(19) United States
(12) Patent Application Publication
(10) Pub. No.: US 2009/0122382 A1
(43) Pub. Date: May 14, 2009

(54) Equalization Device for Optical Pathways Followed by a Plurality of Optical Beams

(75) Inventor: Serge Valette, Grenoble (FR)

Correspondence Address: Nixon Peabody LLP, 200 Page Mill Road, Palo Alto, CA, 94306, US

(73) Assignee: Commissariat A L'Energie Atomique, Paris (FR)

(21) Appl. No.: 11/667,133

(22) PCT Filed: Nov. 18, 2005
(86) PCT No.: PCT/FR05/50962

§ 371 Date: May 4, 2007

(30) Foreign Application Priority Data
Nov. 22, 2004 (FR) 04 52713

(51) Int. Cl. G02B 26/08; G02B 5/08

(52) U.S. Cl. 359/225.1; 359/850

(57) ABSTRACT

Equalization device for the optical pathways of parallel optical beams (f1, f2) between two planes (P1, P2), including a plane of reflection. These beams have an impact (A1, A2, B1, B2) with the planes. It comprises parallel mirrors each intercepting one of the beams at a point (O1, O2). Each beam has a first section (f11, f12) between the plane of reflection (P1) and a mirror, and a second section (f12, f22) between the mirror and the other plane (P2). Two mirrors and the beam sections they intercept allow the two points (O1, O2) to be separated by a distance (d″), parallel to a distance (d′) separating two auxiliary beams (f1′, f2′) symmetric to one of the first sections relative to a normal to the plane of reflection at the associated impact, and allow angle (θ) of the mirrors with the beams to verify:

d″(1−cos 2θ)=d′[sin 2φ(tgφ−sin 2θ)−cos 2φ]φ

being the angle between the sections and a normal to the plane of reflection at the impact.

### TECHNICAL AREA

The present invention concerns a device for equalizing optical pathways followed by a plurality of optical beams in free space.

The area of application of this equalization device is multipath optical systems which can be used in particular for the routing of optical signals. These optical systems are becoming increasingly important with the development of high data rate, optical telecommunications networks.

In these types of optical systems, numerous optical beams travel through the free space between an input plane and an output plane. Basic optical components functioning by reflection or refraction are positioned in these planes and interact with the optical beams. They are arranged in an array or matrix. They may be mirrors or lenses, the latter possibly being used alone or assuming the form of doublets or even of lens glasses of greater or lesser complexity.

These array or matrix arrangements may contain a few optical components up to a few thousand optical components.

### STATE OF PRIOR ART

In these multipath optical systems, assemblies are often encountered such as those illustrated FIGS. 1A, 1B. These show parallel optical beams 1 each reflecting on a mirror 2 of a set of mirrors at one same angle of incidence α. The mirrors 2 are located in one same plane called an input plane Pe. This angle of incidence α is measured relative to a normal to the input plane Pe.

By construction, and to ensure the final separation of the optical beams 1 after their reflection on mirrors 2, they must have a nonzero angle of incidence α.

The optical beams 1 reflected by the mirrors 2 are then each directed onto a lens 3, the lenses 3 being positioned in one same plane called an output plane Ps.

There is a constraint in said assemblies. All the optical pathways followed by the optical beams 1 between the input plane Pe and the output plane Ps must be equal. This constraint can only be met if the reflected optical beams 1, with the output plane Ps, form the angle of incidence α as illustrated FIG. 1A. Yet this configuration is far from being favourable since it causes the lenses 3 to operate under oblique incidence, and in terms of optical aberrations it cannot be considered with conventional lenses. This is all the more so when the angle of incidence α exceeds typical values in the order of 3° to 10°. This problem can evidently be solved through the use of special lenses calculated to function under these conditions. Said lenses are costly however, and their use in high numbers would be economically too penalizing for said multipath optical systems.

It is evidently possible, as shown FIG. 1B, to tilt each of the lenses 3 by an angle α so that each optical beam 1 entering the lens 3 lies normal to the focal plane (image or object) of the lens. However, the fabrication of an array of tilted lenses is not easy, and the complication is heightened for the fabrication of a matrix of lenses since the matrix will no longer be coplanar. Extremely precise, end-to-end assembly of lens arrays must be ensured to obtain a suitable matrix, since the assembled arrays are no longer coplanar.

### DESCRIPTION OF THE INVENTION

The purpose of the present invention, with a view to overcoming the above-mentioned problems, is to propose an equalization device for parallel optical pathways, in free space, between two planes of which one is a reflection plane.

To attain this purpose, the equalization device of optical pathways according to the invention comprises a set of N passive, parallel mirrors, which are not coplanar, each one thereof intercepting at one same angle an optical beam on its pathway between the two planes. The angle of interception of the set of mirrors and the spacing of these mirrors is dependent upon the optical beams and in particular upon their spacing and their angle of incline between the reflection plane and the set of mirrors.

More precisely, the present invention is an equalization device of optical pathways for several parallel optical beams propagating in free space between two planes, of which one is a reflection plane. Each of these optical beams has a point of impact associated with these planes. The device includes a set of passive, parallel non-coplanar mirrors each intended to intercept one of the optical beams at a point of interception at an interception angle θ, each of the optical beams comprising a first section between the reflection plane and a mirror, and a second section between the mirror and the other plane, any two mirrors of the set and the first and second sections of the two optical beams they intercept being arranged so that the two points of interception are separated by a distance d″, calculated parallel to a distance d′ which would separate two auxiliary optical beams, each one symmetric to one of the first sections relative to a normal to the plane of reflection at the associated impact point, the angle of interception θ and distance d″ verifying the equation:

d″(1−cos 2θ)=d′[sin 2φ(tgφ−sin 2θ)−cos 2φ]

where φ is the angle presented by each of the two first sections relative to a normal to the plane of reflection at the associated impact point, the second sections lying normal to the other plane.

It is advantageous that d′=d″, when the points of interception of the mirrors belong to a plane parallel to the plane of reflection.

The mirrors of the set of mirrors may be oriented so that the auxiliary optical beams and the second sections of the optical beams are located on one same side with respect to the first sections of the optical beams.

As a variant, the mirrors of the step of mirrors may be oriented so that the auxiliary optical beams and the second sections of the optical beams are located either side of the first sections of the optical beams.

The mirrors of the set of mirrors may be grouped together on one same face of a single support, this face having a step relief.

The present invention also concerns a dual equalization device to equalize the optical pathways of parallel optical beams propagating in free space between an input plane and an output plane. This dual device comprises two equalization devices for optical pathways, called elementary devices, so characterized, arranged so that the reflection plane relative to one of the elementary devices and the reflection plane relative to the other elementary device form a common plane, and so that the other plane relative to one of the elementary devices is the input plane and the other plane relative to the other elementary device is the output plane.

The single support of one of the elementary devices and the single support of the other elementary device lie side by side so that the faces on which the sets of mirrors are grouped together resemble the slopes of an inverted V-shaped roof, provided with angled steps following the contour of the roof slopes.

In one particularly simple construction, the common plane lies perpendicular to the other plane of each of the elementary devices.

The present invention also concerns an optical deflection module with N paths, comprising at least one optical deflection block with N paths formed of said dual equalization device for optical pathways which cooperates with optical deflection means, the optical deflection means being positioned in the common plane relative to the dual equalization device for optical pathways, the optical deflection means comprising N optical deflection elements and the dual equalization device for optical pathways containing two sets of N fixed mirrors.

The optical deflection elements may be digital mirrors able to tilt about at least one axis so as to take up mechanically defined, angle positions.

If the optical deflection module comprises several optical deflection blocks, these are positioned in cascade, optical conjugation means being inserted between two successive optical deflection blocks, one lying upstream and the other downstream of the optical conjugation means.

The optical conjugation means may be afocal having a given magnification.

The optical conjugation means may comprise at least one optical conjugation module with at least one optical conjugating element which cooperates with several optical pathways of the upstream optical deflection block and/or downstream optical deflection block.

As a variant, the optical conjugation means may comprise as many optical conjugation modules as there are optical pathways, these optical conjugation modules each cooperating with one path of the upstream optical deflection block and one path of the downstream optical deflection block.

The optical conjugation module may comprise a cascade of several optical conjugating elements of lens or mirror type.

The present invention also concerns an optical routing device able to couple each of a plurality of Ne input optical paths to any of a plurality of Ns output optical paths, and to orient each of the incoming optical beams arriving via the input optical paths towards any of the output optical paths. It comprises a cascade through which the optical beams pass, having an input optical deflection module with Ne input paths, a linking module and an output deflection module with Ns output paths. It is characterized in that the input and output optical deflection modules conform to those described above.

The linking module may be of reflective or refractive type.

The routing device may additionally comprise, upstream of the input optical deflection module, an input shaping module able to shape the optical beams before they enter into the input optical deflection module.

The routing device may additionally comprise, downstream of the output optical deflection module, an output shaping device able to shape the optical beams before they enter into the output optical paths.

The input and output shaping modules may be refractive or reflective.

The input and output shaping modules may be afocal systems having a given magnification (G′).

### BRIEF DESCRIPTION OF THE DRAWINGS

The present invention will be better understood on reading the description of examples of embodiment given solely by way of indication and which are in no way limiting, with reference to the appended drawings in which:

FIGS. 1A, 1B (already described) show reflective optical systems not having any equalization device for optical pathways;

FIGS. 2A, 2B show two examples of optical pathway equalization devices according to the invention in a first embodiment;

FIGS. 3A, 3B, 3C show three examples of optical pathway equalization devices according to the invention in a second embodiment;

FIG. 4 shows a prior art, optical pathway equalization device;

FIG. 5 shows a dual equalization device for optical pathways according to the invention, in one application of an optical deflection module;

FIGS. 6A, 6B show two examples of an optical deflection module using the dual equalization device for optical pathways illustrated FIG. 5;

FIGS. 7A to 7E show various variants of the routing devices according to the invention, using optical deflection modules conforming to the one in FIG. 5.

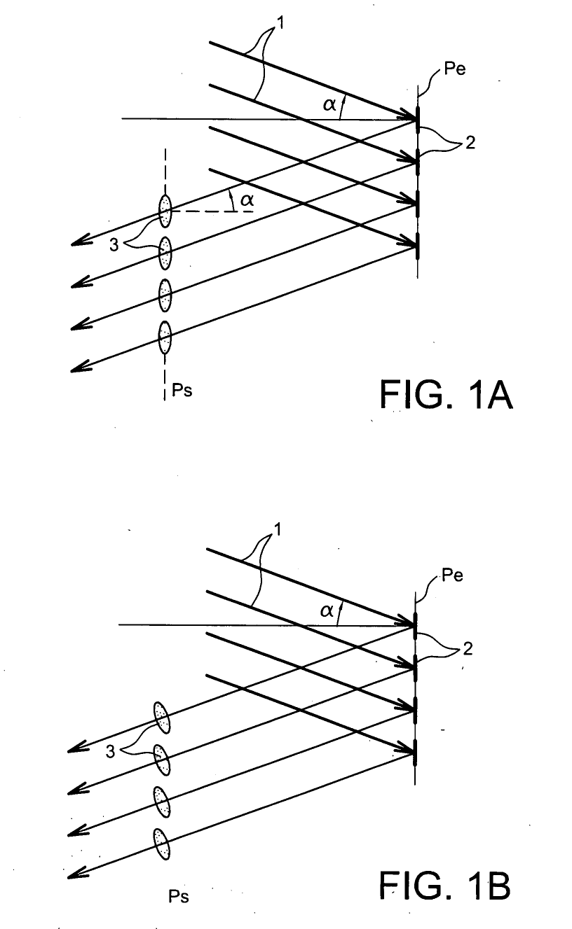

In all these figures, the optical beams are represented by their mean trajectory.

### DETAILED DESCRIPTION OF PARTICULAR EMBODIMENTS

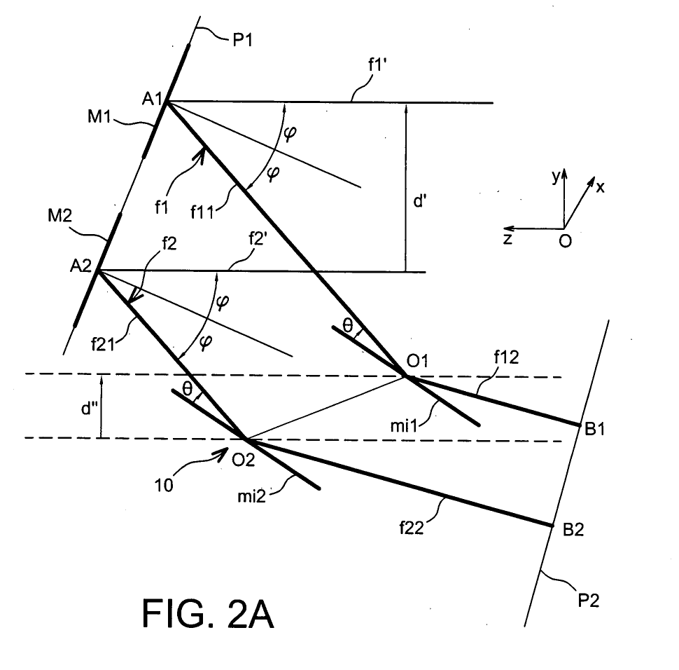

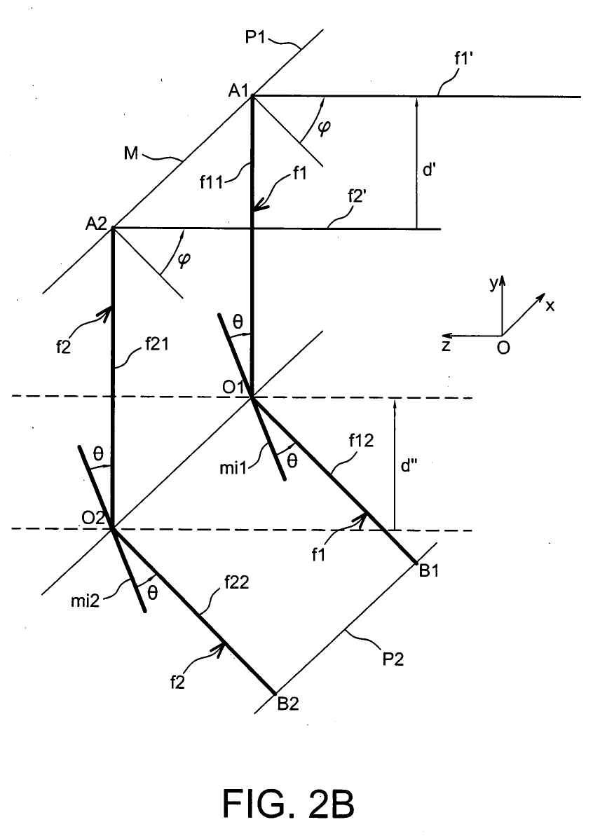

With reference to FIGS. 2A, 2B which show examples of an equalization device 10 for the optical pathways of several parallel optical beams f1, f2 propagating in free space between two planes P1, P2. The direction of propagation may be from plane P1 towards plane P2 or vice-versa. This is why some figures show one direction of propagation and others the reverse direction, and some no direction at all.

One of these planes P1 is a reflection plane and the optical beams f1, f2 each have a point of impact A1, A2 with the plane of reflection P1. This plane of reflection P1 is common to all optical beams f1, f2. The points of impact A1, A2 all belong to the common plane of reflection P1.

Within this context, the optical beams f1, f2 propagating in the vicinity of the plane of reflection P1, between the reflection plane P1 and the other plane P2, all have one same nonzero angle φ with respect to a normal to the plane of reflection P1, at the point of impact of beam f1, f2 with the plane of reflection P1. In other words, each of them is similar to a beam reflected by the plane of reflection P1 or to an incident beam on the plane of reflection P1, depending on the direction of propagation.

References f1′, f2′ denote auxiliary optical beams symmetric to optical beams f1, f2 with respect to a normal to the points of impact A1, A2. They are parallel. They correspond to beams reflected by the plane of reflection P1 if the optical beams f1, f2 are like optical beams incident to the plane of reflection P1, and they correspond to incident optical beams on the plane of reflection P1 if the optical beams f1, f2 are like optical beams reflected by the plane of reflection P1. The choice of alternative is dependent upon the direction of propagation of the optical beams f1, f2 between the plane of reflection P1 and the other plane P2.

In the example given FIGS. 2A, 2B, only two parallel optical beams f1, f2 are shown, but there may be many more and in this case the optical beams can either be coplanar (plane yoz) or matrix-distributed in space (o, x, y, z).

The plane of reflection P1 includes one or more mirrors M1, M2 cooperating with beams f1, f2 which are then either reflected beams, or incident beams. If there are several mirrors, each of them preferably cooperates with one of the optical beams as in FIG. 2A.

In FIG. 2B, the plane of reflection P1 hosts a single mirror M.

The mirror or mirrors M1, M2 substantiating the plane of reflection P1, may be passive i.e. fixed. As a variant, mirrors M1, M2 may be active i.e. mobile. This latter configuration is used in an optical deflection module using the optical pathway equalization device subject of the invention, as will be seen below. If the mirrors are mobile, it is the points of impact A1, A2 which substantiate the plane of reflection P1, they are coplanar. In fact the mirrors are able to tilt about one or more axes, these axes lying the in the plane of reflection P1.

The other plane P2 is normal to the optical beams f1, f2 cooperating with it. Each optical beam f1, f2 has a point of impact with the other plane P2 which is respectively denoted B1, B2.

The optical pathway equalization device 10 subject of the invention is inserted on the pathway of the parallel optical beams f1, f2 between planes P1 et P2.

It has a set of passive mirrors mi1, mi2, each one intercepting one of the parallel optical beams f1, f2. The points of interception are respectively denoted O1, O2. The mirrors mi1, mi2 of the set all have one same angle of interception θ relative to the optical beam f1, f2 it intercepts. These mirrors mi1, mi2 are parallel but they are not coplanar.

Each parallel optical beam f1, f2 has a first section f11, f21, located between the plane of reflection P1 and the optical pathway equalization device 10, which respectively corresponds to segment O1A1, O2A2, and a second section f12, f22, located between the optical pathway equalization device 10 and the other plane P2, which corresponds to segment O1B1, O2B2.

A pair of any parallel optical beams f1, f2 will now be described and the associated pair of mirrors mi1, mi2 of the optical pathway equalization device 10. The distance separating the optical beams f1, f2 from this pair on their first segment is denoted d′. It corresponds to the distance separating the auxiliary optical beams f1′, f2′.

The distance separating the points of interception O1, O2 on mirrors mi1, mi2 of the optical beams f1, f2 of the pair is denoted d″. It is measured parallel to the distance d′ separating the auxiliary optical beams f1′, f2′.

The optical pathway equalization device must be adapted to the configuration of the optical beams f1, f2 with which it is to cooperate. The optical pathway equalization device will make the optical pathways A1O1B1 and A2O2B2 equal.

The pair of parameters d″ et θ, connecting two-by-two the mirrors mi1, mi2 of the optical pathway equalization device 10, depends on the configuration of the optical beams f1, f2 and more particularly on their spacing d′ and their angle φ of incidence or reflection. The pair of parameters d″, θ must satisfy the following relation:

d″/d′=[sin 2φ(tgφ−sin 2θ)−cos 2φ]/(1−cos 2θ)

In FIG. 2A, the parameters d′, d″, θ and φ generally satisfy this equation.

Several values are possible for parameters d″, θ and some are particularly advantageous since they lead to structures easy to construct.

It is possible for example to choose d″=d′, which leads to causing the straight line joining interception points O1, O2 to lie parallel to the straight line joining the points of impact A1, A2 on the reflection plane P1. This construction, illustrated FIG. 2B, is simple to obtain in particular when the points of interception and impact are centres of mirrors. When the optical beams are distributed in space, this amounts to the points of interception being contained in a plane which is parallel to the plane of reflection P1.

This choice leads to fixing the value of parameter θ with respect to φ as follows:

Cot g2θ=sin 2φ.

Another advantageous choice is make angle φ equal to 45°. In this case, the relation becomes: d″/d′=(1−sin 2θ)/(1−cos 2θ). This configuration is also shown FIG. 2B.

When both angle φ equals 45° and d″=d′, this gives θ=22.5°.

In the configuration in FIGS. 2A, 2B, the mirrors mi1, mi2 of the set of mirrors are arranged so that the auxiliary optical beams f′1, f′2 and the second sections f12, f22 of the optical beams f1, f2 are located on the same side with respect to the first sections of optical beams f1, f2. Angle θ is calculated in anti-clockwise direction between the first optical beam section f11, f12 and mirror mi1, mi2.

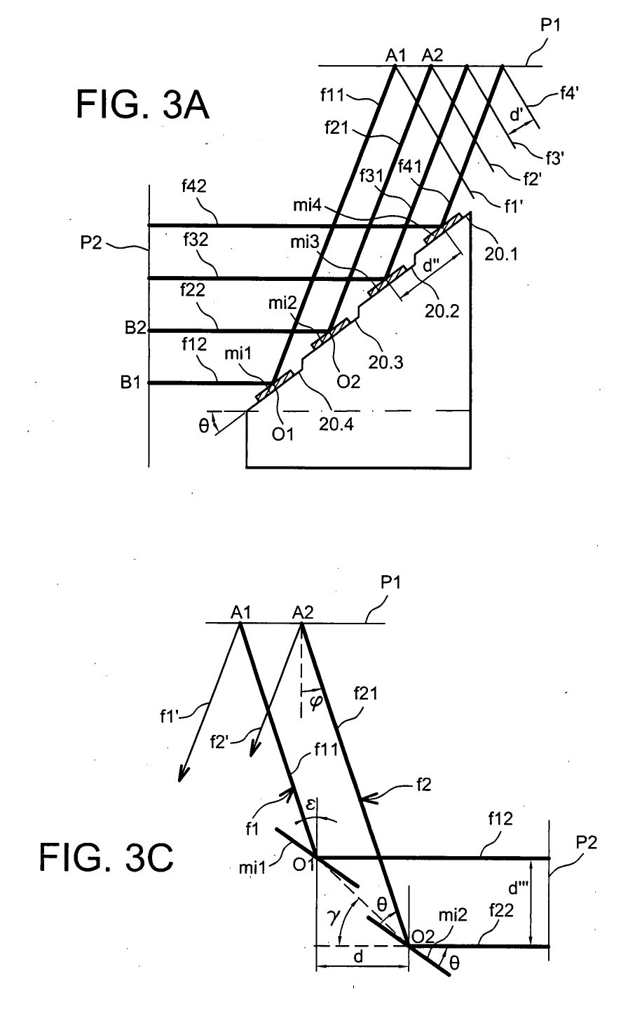

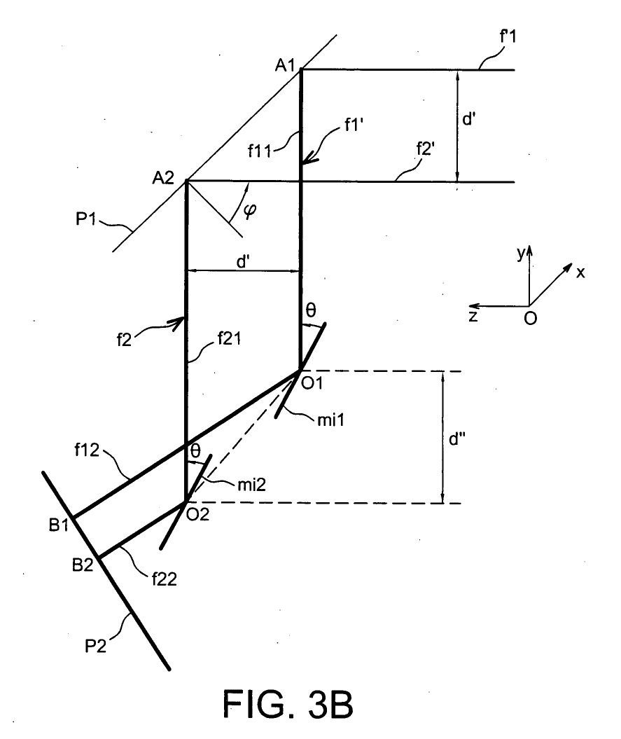

In another advantageous variant illustrated FIG. 3A and showing more than two parallel optical beams f1, f2, f3, f4, it is possible for the mirrors mi1, mi2, mi3, mi4 of the set of mirrors to be arranged so that the auxiliary optical beams f′1, f′2, f′3, f′4 and the second sections f12, f22, f32, f42 of the main optical beams f1, f2, f3, f4 are located either side of the first sections f11, f21, f31, f41 of optical beams f1, f2, f3, f4. In other words, the optical beams may or may not cross each other either side of mirrors mi1 to mi4.

This last variant is advantageous since the mirrors mi1 to mi4 of the set of mirrors may be grouped together on one same face of a single support 20, this face having a relief with steps 20.1 to 20.4, imparting the desired angle θ to the mirrors.

For a choice of angle φ=45°, the following relation must be satisfied:

d″=d′(1+sin 2θ)/(1−cos 2θ)

Reference can be made to FIG. 3B which shows this variant. It is to be noted that in this case, the equation d′=d″ cannot be obtained since the smallest possible value for the ratio d″/d′ is two.

A description will now be made of one advantageous variant in which the plane of reflection P1 and the plane of reflection P2 are perpendicular. Reference is made FIG. 3C. This figure derives from FIG. 3A.

Again consideration is given to mirrors mi1, mi2 of the set and to the optical beams f1, f2 which they intercept, taking them two by two per pair. The denotation d′″ has been given to the distance separating the two optical beams f1, f2 at their second sections f12, f22, i.e. on their pathway between the set of mirrors 10 and the other plane P2.

The denotation d is given to the distance separating the points of interception O1, O2 of the two mirrors mi1, mi2 of the pair, this distance being calculated parallel to the second sections f12, f22 of the optical beams f1, f2.

Reference γ is given to the angle formed by the straight line, joining the points of interception O1, O2 of mirrors mi1, mi2 of the pair, with the optical beam f1, f2 intercepted by one of the mirrors mi1, mi2. This angle γ is different to the angle of interception θ.

The mirrors of the optical pathway equalization device of the invention must be arranged so that:

d/cot gγ=d′″.

It is possible to express cotgγ in relation to angle ε which is the angle of the first section f11, f21 of each of beams f1, f2 with respect to a normal to the second section f12, f22 at the point of interception O1, O2. This gives cotgγ=1/cos ε and ε=π/2−2θ.

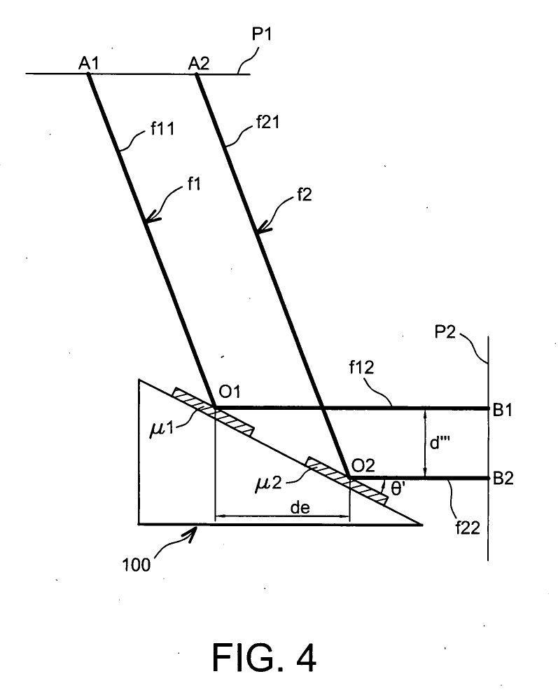

An optical pathway equalization device 100 in which mirrors μ1, μ2 are coplanar, would not provide perfect equality. Reference can be made to FIG. 4 which schematizes such a device in a configuration similar to the one in FIG. 3C. The equivalent magnitude at d is denoted de. The tilt angle formed by the straight line, joining the points of interception O1, O2, with one of the mirrors μ1, μ2 is equal to angle θ (tilt angle of a mirror μ1, μ2 relative to the optical beam f1, f2 intercepted by the mirror).

The equation expressed previously for the case in FIG. 3C would, for FIG. 4, become:

de/cot gθ=d′″

The difference in position of the mirrors of one pair between the two configurations is:

Δ=d′″(cotgθ−cotgγ).

When θ=350 and hence ε=20°, this difference Δ is 0.364d′″. When d′″ equals 500 micrometers, the difference Δ is close to 187 micrometers, which is far from being negligible.

When θ=30° and hence ε=30°, this difference Δ is 0.577d′″. If d′″ equals 500 micrometers, the difference Δ is close to 289 micrometers, which is even more substantial.

When θ=45°, the difference Δ is zero but no practical construction is possible when plane P1 is a perpendicular plane of reflection since the first sections f11, f21 of optical beams, f1, f2 reflect on each other.

When there are more than two parallel optical beams f1 to f4, the positioning of the mirrors is made taking the optical beams in pairs and by applying one of the preceding formulas to the pair of optical beams. If all the optical beams are equidistant, the points of interception O1 to O4 on the mirrors of the set will also be equidistant. Consequently, if all the mirrors are identical, they will from a regular network or a matrix of mirrors.

It will be noted that the distances d′ and d″, such as defined above, do not necessarily lie in the plane yoz (plane of the drawing sheet) but this in no way alters the explanations given.

It is possible to fabricate a dual equalization device 100 for optical pathways propagating in free space between an input plane and an output plane.

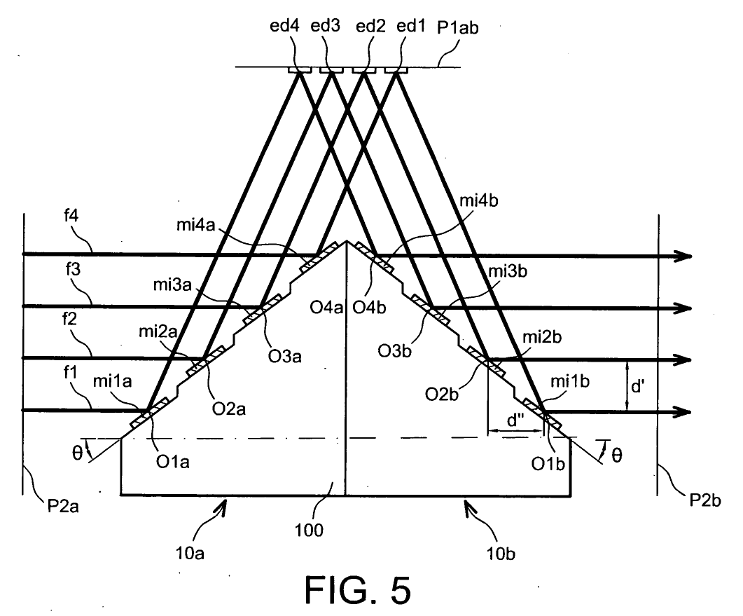

Two optical pathway equalization devices as described, and preferably identical, are associated together, these being called elementary optical pathway equalization devices in the remainder of the description. Reference is made to FIG. 5. In this configuration, two elementary optical pathway equalization devices 10a, 10b are shown such as described previously. These devices are comparable to the one in FIG. 3A, but it could be considered that they are comparable to the one in FIG. 2.

Said dual equalization device 100 for optical pathways comprises two sets of passive mirrors mi1a, mi2a, mi3a, mi4a, mi1b, mi2b, mi3b, mi4b, the mirrors of one set being parallel but not coplanar. In this example, the mirrors of the two sets have one same angle of interception θ. These two devices 10a, 10b cooperate with an arrangement such that the plane of reflection relative to one optical pathway equalization device merges with the plane of reflection relative to the other device 10b. The common plane is referenced P1ab. This common plane P1ab is a plane of reflection. It is oriented perpendicular to the other planes P2a, P2b relative to the two devices 10a, 10b, which are separate and parallel.

The input plane P2a is the other plane with respect to one of the optical pathway equalization devices 10a, and the output plane P2b is the other plane with respect to the other optical pathway equalization device 10b.

In this example, the optical beams f1, f2, f3, f4 are formed of four successive sections: the second and first sections f12a, f22a, f32a, f42a, f11a, f21a, f31a, f41a of the first elementary optical pathway equalization device 10a between the first of the other planes P2a and the common plane P1ab, and the first and second sections f11b, f21b, f31b, f41b of the second elementary optical pathway equalization device 10b between the common plane P1ab and the second of the other planes P2b.

For example, the first sections f11a, f21a, f31a, f41a of optical beams f1 to f4, derived from the first elementary optical pathway equalization device 10a, are reflected by the common plane P1ab and sent towards the second elementary optical pathway equalization device 10b, assuming the shape of the first sections f11b, f21b, f31b, f41b of the optical beams. The mirrors mi1a, mi2a, mi3a, mi4a, mi1b, mi2b, mi3b, mi4b of the two elementary optical pathway equalization devices 10a, 10b are accordingly positioned with respect to each other.

Said dual equalization device 100 for optical pathways has the advantage that the sets of mirrors of the elementary devices can be positioned on the slope faces of a device in the form of an inverted V-shaped roof provided with angled steps following the slope contour of roof-shaped device. The mirrors are arranged on these steps.

Said dual equalization device 100 to equalize optical pathways also has the function of making the second optical beam sections f12a, f22a, f32a, f42a of the first optical pathway equalization device parallel to the second optical beam sections f12b, f22b, f32b, f42b of the second elementary optical pathway equalization device 10b. This was not the case for the elementary optical pathway equalization device.

Said dual equalization device 100 of optical pathways also has the function of reversing the order of the second optical beam sections f12a, f22a, f32a, f42a of the first elementary, optical pathway equalization device 10a with respect to the order of the second optical beam sections f12b, f22b, f32b, f42b of the second elementary, optical pathway equalization device 10b. This inversion must be taken into account when using said dual device in a more complex system.

Said dual equalization device 100 of optical pathways may be used in a simplified multipath optical deflection module as illustrated FIG. 5. In this configuration, the plane of reflection P1ab comprises optical deflection means 21 formed of a series of optical deflection elements ed1 to ed4. The number of optical deflection elements ed1 to ed4 corresponds to the number N of paths. The number of passive mirrors mi1a, mi2a, mi3a, mi4a per set also corresponds to the number of paths.

In this example, the optical deflection elements ed1 to ed4 are tilting mirrors able to take up two or more angle positions as described in patent application FR-A-2 821 678. They are digital mirrors (preferably micro-mirrors) which are able take up a finite number of stable, defined angle positions. These angle positions may be taken up by causing the mirror to tilt about a single tilt axis or about several axes. These mirrors may for example have two tilt axes and two angle positions per axis. These stable angle positions of the mirror may be defined by stops against which the mirror comes into contact. No stop is shown to avoid over-crowding the figures. One tilt axis could be in the plane of the drawing sheet. We therefore have one axis perpendicular to the sheet and one axis perpendicular to the first axis in the plane of the mirrors.

It is not necessary to describe in further detail the optical deflection elements or their control, since they are well known optical components in the area of optical telecommunications.

The optical paths are substantiated by optical beams f1 to f4 upstream and downstream of the dual equalization device 100 of optical pathways. The optical deflection means 21 receive the optical beams f1 to f4 propagating along these optical paths and deflect them, causing them each to take a direction among several possible directions.

The first set of mirrors mi1a to mi4a equalizes the distance between the first other plane P2a and the common plane P1ab, and the second set of mirrors equalizes the distance between the common plane P1ab and the second other plane P2b.

Therefore in the optical deflection module in FIG. 5, the optical beams undergo three successive reflections, the first at the first optical pathway equalization device 10a, upstream of optical deflection means 21, the second at the optical deflection means 21, and the third at the second optical pathway equalization device 10b, downstream of the optical deflection means 21.

In the remainder of the description, a simplified optical deflection module such as the one in FIG. 5, i.e. having only one dual equalization device 100 for optical pathways and deflection means 21, will be called an optical deflection block.

It is possible to construct a more complex deflection module in which the optical beams can take up even more angle positions, by placing in cascade several optical deflection blocks 201, 202 separated by optical conjugation means 40. Optical deflection elements can be used that are able to take up few stable angle positions (e.g. two per tilt axis). Therefore by placing in cascade M optical deflection elements, 2^{M} angle positions can be generated for optical deflection elements having one tilt axis and two positions per axis, and 4^{M} angle positions for optical deflection elements having two tilt axes and two positions per axis.

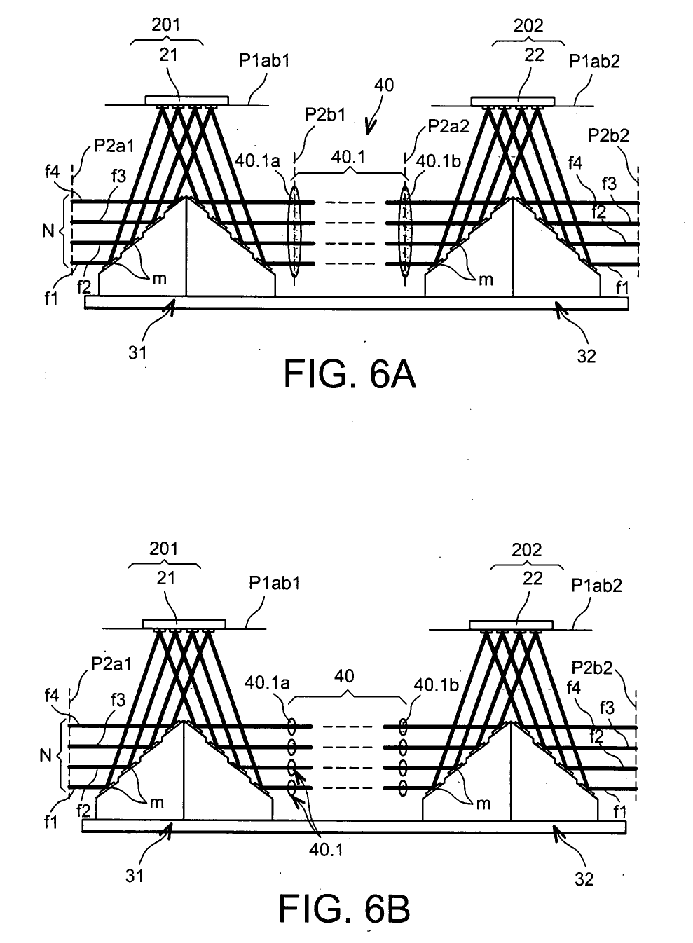

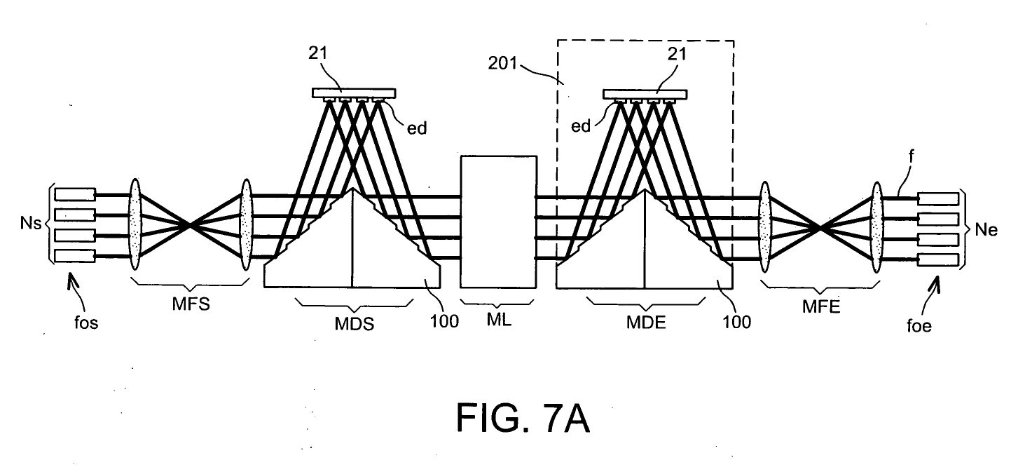

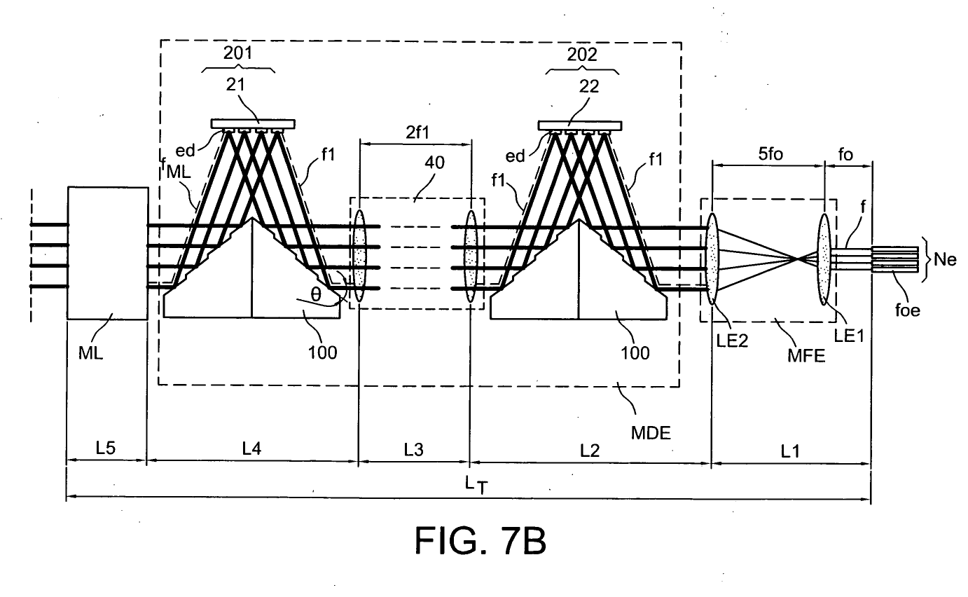

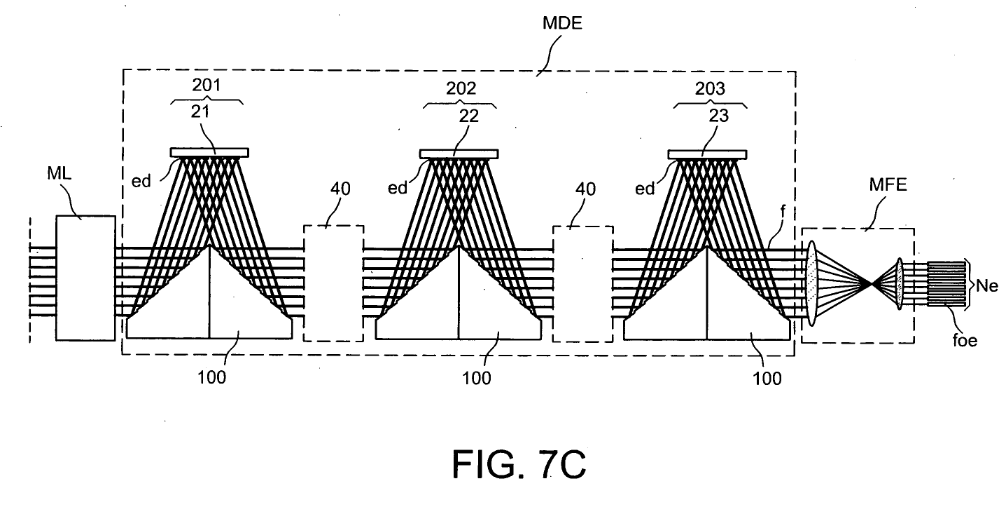

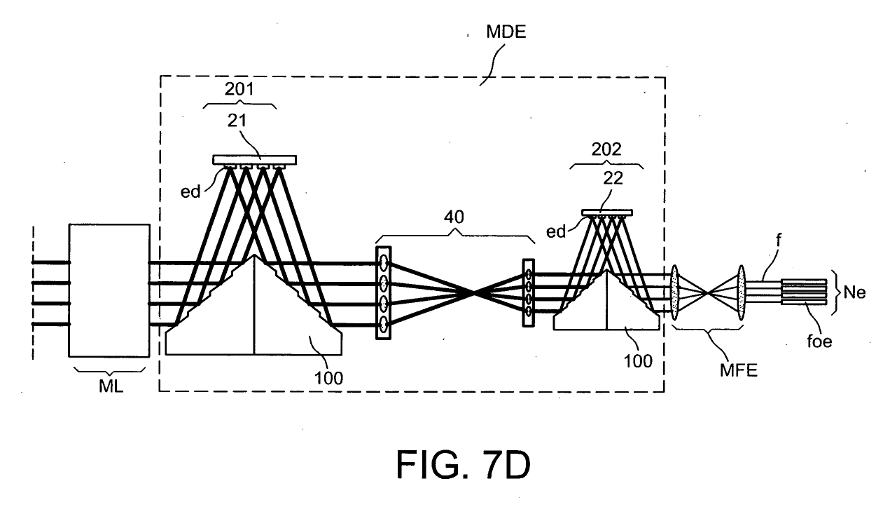

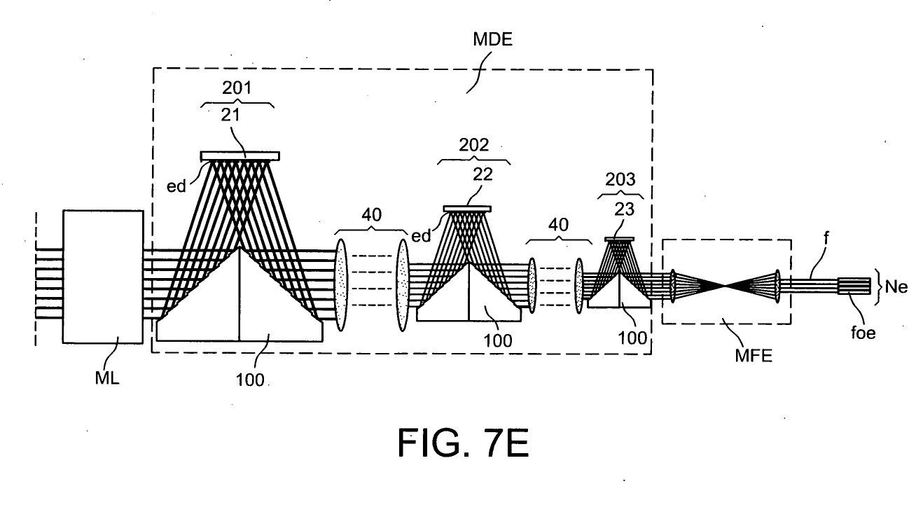

In FIGS. 6A, 6B, two optical deflection blocks in cascade 201, 202 are shown. It could be contemplated to arrange more than two in cascade as shown FIG. 7C.

The sets of fixed mirrors m of each of the dual equalization devices 100 of optical pathways comprise as many mirrors m as optical paths, i.e. N. The optical deflection means 21, 22 of each of the optical deflection blocks 201, 202 are positioned in the common plane P1ab1, P1ab2 relative to the respective dual equalization device for optical pathways.

Said optical deflection means 21, 22 also comprise N (in the example N equals 4 when operating in one plane or 16 when operating in space) elementary optical deflection elements ed.

The optical conjugation means 40 extend between the second of the other planes P2b1 of one of the dual optical pathway equalization devices 31 and the first of the other planes P2a2 of the other dual optical pathway equalization device 32. The optical conjugation means 40 comprise one or more optical conjugation modules 40.1 each formed of several optical conjugating elements 40.1a, 40.1b in cascade, these optical conjugating elements being of lens or mirror type (as in FIG. 7C). Each optical deflection element ed of the optical deflection means 21 of an optical deflection block (referenced 201 for example) in the cascade is optically conjugated with the optical deflection element ed, following or preceding it, of the optical deflection means of another optical deflection block (referenced 202 for example) through an object-image relationship via the optical conjugation means 40.

At least one of the optical conjugating elements 40.1a, 40.1b is common to several optical beams issuing from one of the optical pathway equalization devices 31, and hence is common to several optical paths.

In FIG. 6A which only shows a particular example, the optical conjugation means 40 are formed of a single optical conjugation module 40.1. This module is a lens doublet 40.1a, 40.1b. The lenses of the doublet are common to all N paths. It could have been contemplated that the optical conjugation means 40 could be formed of several optical conjugation modules in parallel, one module being common to at least two optical paths.

The lenses 40.1a, 40.1b of the doublet are crossed by the optical beams f1 to f4 issuing from the first dual, optical pathway equalization device 31, and which have been deflected by the optical deflection means 21 of the optical deflection block 201. When passing through the optical conjugation means 40, the order of the optical beams f1 to f4 is reversed.

The optical beams f1 to f4, on leaving the optical conjugation means 40, attack the dual optical pathway equalization device 32 of the other optical deflection block 202, and will be deflected by the optical deflection means 22 of this block 202.

The optical conjugation means 40 form an afocal system which will have a given magnification G.

This magnification may or may not have unit value. If G=1, the two dual optical pathway equalization devices 31, 32 are identical. The pitch of the mirrors m of the sets of mirrors is identical from one dual optical pathway equalization device 31 to another 32. The same applies to the pitch of the optical deflection elements ed from one optical deflection block 201 to another 202. This configuration has the advantage of preserving perfect symmetry from one optical deflection block a 201 to another 202 and is particularly easy to implement.

It could evidently be considered that the magnification G is different from one, in this case the sets of mirrors m of the two dual optical pathway equalization devices 31, 32 will be configured accordingly.

So that the optical deflection module is able to function under the best conditions, and in particular so that the cascade configuration allows multiplication of the angle deflection positions of each of the optical beams f1 to f4 bijectively and with more or less constant angle differences, arrangements are made so that the angle excursion of the optical deflection elements ed of optical deflection block 202 positioned downstream of the optical conjugation means 40 is twice that of the optical deflection elements ed of the optical deflection block 201 positioned upstream of the optical conjugation means 40, when the optical deflection elements comprise two angle positions per tilt axis.

More generally it can be shown that for identical optical deflection elements ed allowing P separate angle positions, the magnification G allowing equidistant angle positions to be obtained in each optical deflection block is given by G=P.Δθᵢ/Δθᵢ₊₁ where Δθᵢ is the angle deviation of the optical deflection elements ed of the optical deflection block in row i (called upstream block) and Δθᵢ₊₁ is the angle deviation of the optical deflection elements ed of the optical deflection block in row i+1 located downstream of the optical deflection block in row i. It can be verified that when P=2 and G=2 one effectively finds Δθᵢ/Δθᵢ₊₁=1.

For the configuration shown FIGS. 6A, 6B et seq which comprises optical conjugation means, the optical beams may be Gaussian-like beams. These Gaussian beams have the property of remaining Gaussian over a succession of optical conjugations. Their minimum radius ω often called their <<waist >> determines the characteristics of the optical beam and in particular its divergence.

In the configuration of the optical conjugation means 40 in FIG. 6A with a lens 40.1a, 40.1b through which several optical beams pass, the minimum radius ω and the distance d separating two neighbouring beams (e.g. on one or other of the sides of the optical conjugation means) are multiplied by magnification G after each passing in the optical conjugation means 40. A magnification G of one makes it possible to keep this distance identical from one optical deflection block 201 to another 202. The dual optical pathway equalization devices 31, 32 may be identical from one block 201 to another 202.

In FIGS. 7D and 7E, a routing device is shown comprising optical deflection modules 201, 202, 203 whose optical conjugation means 40 have a magnification different to one. The dual optical pathway equalization devices 100 differ in size. They are related by proportionality. The size and position of their mirrors are adapted to the optical beams they are to intercept and reflect.

In FIG. 6B, the optical conjugation means 40, instead of comprising an optical conjugation module common to several optical paths, comprise one optical conjugation module 40.1 per optical path. These modules are formed of a doublet of lenses 40.1a, 40.1b. Each of these lenses is only crossed by one of the optical beams f1 to f4. The lenses in one same plane may be grouped together in an array or matrix.

In the configuration FIG. 6B with optical conjugation means which use lenses crossed by only one optical beam, the minimum radius ω and distance d are independent, and only the minimum radius ω is affected by magnification. On each pass through the optical conjugation means this minimum radius ω is multiplied by magnification G. Distance d remains constant either side of the optical conjugation means.

This latter configuration is more suitable when not too many optical beams are involved, as otherwise the positioning of the lenses soon becomes difficult.

The configuration in FIG. 6A is suitable for configurations in which many optical beams are involved. The configuration in FIG. 6A uses far less optical components than the one in FIG. 6B. It can use conventional low-cost lenses, and their positioning is much simpler than when at least one lens is used per optical path. The only constraint of the configuration shown 6A is that the performance requirements for the optical conjugation means with the lens doublet, in terms of field angle and digital opening, are much stricter than those required for each individual lens of the array or matrix. However this constraint does not give rise to any problem in the light of the range of lenses currently existing on the market. These two FIGS. 6A, 6B illustrate two extremes of a series of possible configurations.

The addition of a dual, optical pathway equalization device 100 to an optical deflection module 201, 202 comprising optical conjugation means 40, whilst causing the optical deflection means to function with a nonzero angle of incidence to ensure the desired separation in space between the incident and reflected optical beams, makes it possible to maintain an identical object-image optical conjugation relationship for each of the N optical paths. The optical conjugation means then operate with substantially zero incidence, which avoids the onset of optical aberrations.

Reference will now be made to FIGS. 7A to 7E showing routing devices which use comparable optical deflection modules 201 to 203 to those in FIGS. 5 and 6.

A routing device allows each of a plurality of Ne input optical paths to be coupled to any of a plurality of Ns output optical paths, and to orient optical beams f conveyed by the Ne input paths towards any of the Ns output optical paths.

The routing devices described below are of N×N type and this denotation N×N indicates that the routing devices can simultaneously route N optical beams causing them each to take up a position among N possible positions between the input and output of the device. Evidently the routing devices could be of N×M type.

Reference may be made to patent application FR-A-2 821 681 which describes the general principle of a routing device on which the routing device subject of the invention is based.

A routing device comprises a cascade through which pass optical beams f delivered by the Ne input optical paths, this cascade comprising an input optical deflection module MDE, an output optical deflection module MDS and between them a linking module ML.

The input optical deflection module MDE, for each of the optical beams arriving via the Ne input optical paths, is able to generate a potential number of angle positions at least equal to the number Ns of output optical paths.

The output optical deflection module MDS is able to intercept all the optical beam passing through the linking module ML, and to deliver as many optical beams as output optical paths.

The input optical deflection module MDE and the output optical deflection module MDS are comparable to those described in FIG. 5 or 6.

The input optical deflection module MDE and the output optical deflection module MDS have symmetric structures with respect to the linking module ML only with a N×N routing device. If the routing device is of N×M type, the number of optical deflection blocks may be different in the input optical deflection module and output optical deflection module.

The linking module ML may be of refractive type formed of at least one lens, or reflective formed of at least one mirror. Its function is to transform all the angle directions of the optical beams f leaving the input optical deflection module MDE into a set of space positions for the optical beams f which are to enter into the output optical deflection module MDS. Said linking module ML does not give rise to any problems for those skilled in the art.

The Ne input optical paths are substantiated by a bunch of optic fibres foe. The Ns output optical paths are substantiated by a bunch of optic fibres fos. The optic fibres f arrive in the routing device via the input optic fibres foe, and leave it via the output optic fibres fos.

In the cascade and upstream of the input optical deflection module MDE, provision is made for an input shaping module MFE intended to shape the optical beams f arriving via the input fibres foe to adapt them to the input optical deflection module MDE. Similarly, downstream of the output optical deflection module MDS provision is made for an output shaping module MFS intended to shape the optical beams f leaving the output optical deflection module MFS to adapt them to the output optic fibres fos in which they are going to propagate.

The purpose of shaping is to impart appropriate divergence and minimum radius to beams f. The shaping modules MFE, MFS have a given magnification G′ which may or may not be equal to one. Magnification G′ may be equal to magnification G of the one or more optical conjugation means 40 of the input or output optical deflection modules MDE. The shaping modules MFE, MFS are afocal systems.

The shaping modules MFE, MFS may be formed of one or more lenses. In some FIG. 7, they are in the form of doublets but many other configurations are possible. The two lenses of the doublet are crossed by all the beams f, but it could have been possible to provide for several lenses in parallel, each one crossed by one optical beam or a fraction of the optical beams involved. These lenses may be grouped into a matrix. In FIG. 7B, it is assumed that they are reflective.

In FIG. 7A, the routing device is simplified. It is an N×N routing device in which N=4 and whose magnification is 1. The optical deflection modules MDE, MDS only include one optical deflection block 201 with one dual optical pathway equalization device 100 which cooperates with optical deflection means 21. Each of the optical deflection elements ed of the optical deflection means 21 can tilt about two axes and take up two mechanically defined positions for each of the axes.

Only the routing device in FIG. 7A is shown completely. The routing devices in FIGS. 7B to 7E are only shown in part. They only comprise a first part extending from the input optic fibres foe to the input optical deflection module MDE and linking module ML. That part extending from the output optical deflection module to the output optic fibres is omitted, but it would be symmetric to the first part relative to the linking module ML.

In FIG. 7B, the routing device is an N×N device in which N=16 with a magnification of 4. The input MDE and output MDS optical deflection modules comprise a cascade with two optical deflection blocks 201, 202 separated by optical conjugation means 40. The magnification of the optical conjugation means 40 equals 1 and this choice is advantageous since the two optical deflection blocks 100 of an optical deflection module MDE are identical. Each of the lenses of the optical conjugation means 40 is crossed by all the optical beams f involved. Each of the optical deflection elements ed is able to tilt about two axes and take up two mechanically defined positions for each of the axes. The input optical deflection module MDE has a magnification of four.

This figure is an example in which the initial hypotheses are the following:
size of the optical beams downstream of the input shaping means MFE: 80 micrometers.

size of the optical beams upstream of the input shaping means MFE: 20 micrometers.

wavelength of the optical beams: 1.55 micrometers.

The input shaping means MFE comprise a first lens LE1 of focal length f0=1.5 mm and a second lens LE2 of focal length f1=4f0=5 mm, therefore the distance between the two lenses LE1, LE2 (or the distance between the input and the output of the input shaping means) is 5f0.

The optical conjugation means 40 have a magnification of one, and the distance separating their constituent two conjugating elements is 2f1. The focal length of each of their constituent lenses is f1.

Magnitude F_{ML} represents the focal length of the linking module ML.

The angle of interception θ formed by the mirrors of the dual optical equalization devices with the optical beams is chosen to be 20°. Other values could be chosen but it is recommended that it should be neither too small, otherwise the optical deflection means will be positioned too high, nor too great otherwise the length of the optical deflection module MDE will be too long. This angle determines the compactness of the optical deflection module.

FIG. 7B illustrates the different lengths of the constituents of that of the routing device shown. Distance L1 between the input optic fibres foe and the input of the input shaping module MFE is 6f0, i.e. approximately 9 millimetres. Distance L2 between the input and output of the optical deflection block 202 is approximately 5 millimetres. Distance L3 between the input and output of the optical conjugation means 40 is approximately 2f1 i.e. 10 millimetres. Distance L4 between the input and output of the optical deflection block 201 is approximately 5 millimetres. Distance L5 between the input and output of the linking module ML is approximately 2 millimetres. This gives a total length L_{T} of approximately 31 millimetres.

In FIG. 7C, the routing device is an N×N device with N=64. The input MDE and output MDS optical deflection modules comprise a cascade with three optical deflection blocks 201, 202, 203, two consecutive blocks being separated by optical conjugation means 40. They have a magnification of one. Evidently, it would have been possible to use optical conjugation means conforming to those illustrated FIG. 6A. The magnification of the optical conjugation means 40 is 1 and the three optical deflection blocks 201, 202, 203 of one module are identical. It is assumed that the optical conjugation means are reflective with mirrors which cooperate with all the optical beams involved. Each of the optical deflection elements ed of the optical deflection means 21, 22, 23 is able to tilt about two axes and to take up two mechanically defined positions for each of the axes. In the two preceding configurations, the angle deviation of the optical deflection elements of an optical deflection block is twice that of the optical deflection elements of the optical deflection block preceding it.

In FIG. 7D, the routing device is a N×N device with N=16. The input MDE and output MDS optical deflection modules contain a cascade with two optical deflection blocks 201, 202 separated by optical conjugation means 40. They have a magnification of two. The magnification of the optical conjugation means 40 is 2 and the two optical deflection blocks 201, 202 of one module differ in size. The optical conjugation means 40 are similar to those illustrated FIG. 6B. Each of the lenses of the optical conjugation means 40 is crossed by a single optical beam f. Each of the optical deflection elements ed of the optical deflection means 21, 22 is able to tilt about two axes and to take up two mechanically defined positions for each of the axes. In this example, the optical conjugation means 40 comprises matrices of lenses, each lens only being crossed by one optical beam.

In FIG. 7E, the routing device is a N×N device in which N=64. The input MDE and output MDS optical deflection modules comprise a cascade with three optical deflection blocks 201, 202, 203, two consecutive blocks being separated by optical conjugation means 40. They have a magnification of two. The magnification of the optical conjugation means 40 is 2 and the three optical deflection blocks 201, 202, 203 of one module differ in size. Each of the optical deflection elements ed of the optical deflection means 21, 22, 23 is able to tilt about two axes and to take up two mechanically defined positions for each of the axes.

The choice of a magnification of two allows the angle deviation of the optical deflection elements ed to be the same from one optical deflection block 201 to another 202. The formula G=P.Δθᵢ/Δθᵢ₊₁ given above with G=2 and P=2 effectively gives Δθᵢ/Δθᵢ₊₁=1.

A routing device of the invention is much simpler than the one described in patent application FR-A-2 821 678. It is also more compact through use of the dual equalization devices of the optical pathways, and is easier to assemble through the use of lenses for several optical paths in the optical conjugation means. It uses commercially available, low-cost optical components. These three improvements lead to a significant reduction in the cost of the complete routing device.

Although several embodiments of the present invention have been illustrated and described in detail, it will be understood that different changes and modifications can be made thereto without departing from the scope of the invention. In the routing devices of the invention, the optical conjugation means could conform to those illustrated FIG. 6B, or could be intermediate between those shown FIGS. 6A and 6B.

1. Equalization device for the optical pathways of several parallel optical beams (f1, f2) propagating in free space between two planes (P1, P2) of which one is a plane of reflection, each of these optical beams having a point of impact (A1, A2, B1, B2) associated with these planes, characterized in that it comprises a set of passive, non-coplanar, parallel mirrors (mi1, mi2) each intended to intercept one of the optical beams with an angle of interception θ at a point of interception (O1, O2), each of the optical beams comprising a first section (f11, f12) between the plane of reflection and a mirror, and a second section (f12, f22) between the mirror and the other plane, any two mirrors of the set and the first and second sections of the two optical beams they intercept being arranged so that the two points of interception (O1, O2) are separated by a distance d″, calculated parallel to a distance d′ which would separate two auxiliary optical beams (f1′, f2′), each symmetric to one of the first sections with respect to a normal to the plane of reflection at the associated point of impact, the angle of interception θ and distance d″ satisfying the relation:
d″(1−cos 2θ)=d′[sin 2φ(tgφ−sin 2θ)−cos 2φ]
where φ is the angle presented by each of the two first sections with respect to a normal to the plane of reflection at the associated point of impact, the second sections (f12, f22) lying normal to the other plane (P2).

2. Equalization device for optical pathways according to claim 1, wherein d′=d″.

3. Equalization device for optical pathways according to claim 1, wherein the mirrors (mi1, mi2) of the set of mirrors are oriented so that the auxiliary optical beams (f′1, f′2) and the second sections (f12, f22) of the optical beams are located on one same side with respect to the first sections (f11, f12) of the optical beams (f1, f2).

4. Equalization device optical pathways according to claim 1, wherein the mirrors (mi1, mi2) of the set of mirrors are oriented so that the auxiliary optical beams (f′1, f′2) and the second sections (f12, f22) of the optical beams are located either side of the first sections (f11, f12) of the optical beams (f1, f2).

5. Equalization device for optical pathways according to claim 4, wherein the mirrors (mi1 to mi4) of the set of mirrors are grouped together on one same face of a single support (20), this face having a relief with steps (20.1 to 20.4).

6. Dual equalization device for the optical pathways of parallel optical beams propagating in free space between an input plane (P2a), and an output plane (P2b), wherein it comprises two optical pathway equalization devices (10a, 10b) called elementary devices conformed according to claim 1, arranged so that the plane of reflection relative to one of the elementary devices and the plane of reflection relative to the other of the elementary devices form a common plane (P1ab), and in that the other plane relative to one of the elementary devices is the input plane (P2a) and the other plane relative to the other elementary device is the output plane (P2b).

7. Dual equalization device for optical pathways according to claim 5, wherein the single support of one of the elementary devices and the single support of the other elementary device lie side by side, so that the faces on which the mirrors of the sets are grouped together resemble the slopes of an inverted V-shaped roof provided with angled steps following the slope contour of the roof-shaped device.

8. Dual equalization device for optical pathways according to claim 6, wherein the common plane (P1ab) is perpendicular to the other plane (P2a, P2b) of each of the elementary devices (10a, 10b).

9. Optical deflection module with N paths, comprising at least one optical deflection block (201, 202) with N paths formed of a dual, optical pathway equalization device (100) according to claim 6 and of optical deflection means (21, 22) which cooperate with the dual, optical pathway equalization device (100), the optical deflection means (21, 22) being placed in the common plane (P1ab) relative to the dual, optical pathway equalization device (100) and comprising N optical deflection elements (ed), the optical pathway equalization device comprising two sets of N fixed mirrors (m).

10. Optical deflection module according to claim 9, wherein the optical deflection elements (ed) are digital mirrors able to tilt about at least one axis so as to take up mechanically defined angle positions.

11. Optical deflection module according to claim 9, wherein it comprises several optical deflection blocks (201, 202) positioned in cascade, optical conjugation means (40) being inserted between two successive optical deflection blocks (201, 202), one lying upstream and the other downstream of the optical conjugation means (40).

12. Optical deflection module according to claim 11, wherein the optical conjugation means (40) are afocal and have a given magnification (G).

13. Optical deflection module according to claim 11, wherein the optical conjugation means (40) comprise at least one optical conjugation module with at least one optical conjugating element which cooperates with several optical paths of the upstream optical deflection block (201) and/or of the downstream optical deflection block (202).

14. Optical deflection module according to claim 11, wherein the optical conjugation means (40) comprise as many optical conjugation modules as optical paths, these optical conjugation modules each cooperating with one path of the upstream optical deflection block and one path of the downstream optical deflection block.

15. Optical deflection module according to claim 13, wherein an optical conjugation module (40) comprises a cascade of several refractive or reflective optical elements.

16. Optical deflection module according to claim 12, wherein when the optical deflection elements have P mechanically defined angle positions, the optical deflection elements of one optical deflection block have an angle deviation which is equal to that of the optical deflection elements of the optical deflection block preceding it, multiplied by the ratio P/G.

17. Routing device able to couple each of a plurality of Ne input optical paths (foe) to any of a plurality of Ns output optical paths (fos) and to orient each of the optical beams (f) arriving via the Ne input optical paths (foe) towards any of the Ns output optical paths (fos) comprising a cascade crossed by the optical beams (f) with an input optical deflection module (MDE) having Ne input paths, a linking module (ML) and an output optical deflection module (MDS) having NS output paths, characterized in that the input optical deflection module (MDE) and the output optical deflection module (MDS) conform to claim 9.

18. Routing device according to claim 17, wherein the linking module (ML) is reflective or refractive.

19. Routing device according to claim 17, wherein in addition, upstream of the input optical deflection module (MDE) it comprises an input shaping module (MFE) able to shape the optical beams (f) before they enter into the input optical deflection module (MDE).

20. Routing device according to any claim 17, wherein, in addition, downstream of the output optical deflection module (MDS) it comprises an output shaping module (MFS) able to shape the optical beams (f) before they propagate in the output optical paths (fos).

21. Routing device according to claim 19, wherein the input shaping module (MFE) and the output shaping module (MFS) are refractive or reflective.

22. Routing device according to claim 19, wherein the input and output shaping modules (MFE, MFS) are afocal systems having a given magnification (G′).
